(19) United States
(12) Patent Application Publication
(10) Pub. No.: US 2024/0309490 A1
(43) Pub. Date: Sep. 19, 2024

(54) Metal ION Recovery from a Bound Chelate/Sequestering-Agent Solution

(71) Applicant: RADTRAN LLC, Centennial, CO (US)

(72) Inventors: Saleem S. DRERA, Centennial, CO (US); Andrew EDWARDS, Centennial, CO (US)

(21) Appl. No.: 18/665,077

(22) Filed: May 15, 2024

Related U.S. Application Data
(63) Continuation of application No. PCT/US2022/051423, filed on Nov. 30, 2022.
(60) Provisional application No. 63/285,424, filed on Dec. 2, 2021.

(51) Int. Cl. C22B 60/00; C22B 3/06; C22B 3/16

(52) U.S. Cl. CPC C22B 60/00; C22B 3/06; C22B 3/165

(57) ABSTRACT

Methods for the recovery of metal ions from an aqueous metal-chelator solution are disclosed. In some embodiments, a method includes dissociating a metal ion from a chelating agent to form a free chelating agent and then precipitating or removing the free chelating agent, wherein at least some of the metal ions remain in an acid solution for further processing. For example, the metal ions can be used in other applications, such as in medical applications and industrial applications.

### CROSS-REFERENCE TO RELATED APPLICATIONS

This application is a continuation of International Patent Application No. PCT/US2022/051423, entitled “Metal Ion Recovery From A Bound Chelate/Sequestering-Agent Solution,” filed Nov. 30, 2022, which claims the benefit of U.S. Provisional Patent Application No. 63/285,424, entitled “Metal Ion Recovery From A Bound Chelate/Sequestering-Agent Solution,” filed Dec. 2, 2021. Each of the above-identified patent applications is hereby incorporated by reference in its entirety.

### BACKGROUND

Solutions with chelating agents are used to bind metal ions to reduce their free concentration in the solution.

### SUMMARY OF THE DISCLOSURE

Solutions with chelating agents (sequestering agents) may be used to bind metal ions to reduce the concentration of the metal ions in a broad range of processes, including metal ions in water and/or soil. The metal ions are sometimes removed from the chelating agents so that the chelating agent can be recycled to capture additional metal ions in the future, and the metal ions are discarded as waste. Instead of treating the metal ions as waste, the present disclosure describes methods where metal ions are treated as a desired product. For example, the metal ion can be a product that is utilized for further applications, such as medical applications or industrial applications. The present disclosure describes methods and systems to recover metal ions as a desired product.

In one aspect, the present disclosure relates to a method including: (a) adding acid to an aqueous metal-chelator solution, wherein, prior to the adding acid step, the aqueous metal-chelator solution includes metal ions bound to a chelating agent, wherein, due to the adding acid step, the metal ions disassociate from the chelating agent, and wherein, due to the adding acid step, the chelating agent precipitates thereby forming precipitated chelates, and (b) removing the precipitated chelates, thereby forming a concentrated aqueous metal ion solution.

In some embodiments, the present disclosure includes, prior to the adding acid step: exposing a solid substrate to an initial solution including the metal ions; capturing the metal ions with the solid substrate from the initial solution; exposing the solid substrate with the captured metal ions to a chelator solution; and extracting the metal ions from the solid substrate with the chelator solution to form the aqueous metal-chelator solution, thereby transferring the metal ions back into solution.

In some embodiments, the present disclosure includes that the metal ions in the initial solution have a concentration ranging from 1 part per trillion to 100 parts per million.

In some embodiments, the present disclosure includes, prior to the adding acid step, evaporating the aqueous metal-chelator solution.

In some embodiments, the present disclosure includes, prior to the adding acid step, the aqueous metal-chelator solution includes a metal-chelator molar concentration ranging from 0.01 nanomolar to 0.25 molar.

In some embodiments, the present disclosure includes that the aqueous metal-chelator solution includes radium isotopes.

In some embodiments, the present disclosure includes that the radium isotopes include Ra-223, Ra-224, Ra-225, Ra-226, or Ra-228.

In some embodiments, the present disclosure includes that the chelating agent includes ethylenediaminetetraacetic acid, nitrilotriacetic acid, or citric acid.

In some embodiments, the present disclosure includes that, prior to the adding acid step, the aqueous metal-chelator solution includes a pH ranging from 4 to 7.

In some embodiments, the present disclosure includes that, due to the adding acid step, the metal ions disassociate from the chelating agent at a pH of 4.5 or less.

In some embodiments, the present disclosure includes that, due to the adding acid step, the chelating agent precipitates from the aqueous metal-chelator solution at a pH of 2.5 or less.

In some embodiments, the present disclosure includes that, due to the adding acid step, the aqueous metal-chelator solution realizes a pH of not greater than 2.5.

In some embodiments, the present disclosure includes that the acid includes hydrochloric acid or nitric acid.

In some embodiments, the present disclosure includes recovering the metal ions from the concentrated aqueous metal ion solution.

In some embodiments, the present disclosure includes using the concentrated aqueous metal ion solution.

In some embodiments, the present disclosure includes that using the concentrated aqueous metal ion solution includes using the metal ions of the concentrated aqueous metal ion solution in a medical application.

In some embodiments, the present disclosure includes that using the concentrated aqueous metal ion solution includes using the metal ions of the concentrated aqueous metal ion solution as a source material to produce Pb-212, Bi-212, Ac-225, Th-227, Th-228, Ra-223, or Ra-224.

In some embodiments, the present disclosure includes that the concentrated aqueous metal ion solution includes less than 10% of the chelating agent from the aqueous metal-chelator solution.

In another aspect, the present disclosure relates to an aqueous-based solution, including: a molar concentration of Ra-226 ions ranging from 0.1 nanomolar to 10 micromolar.

In some embodiments, the present disclosure relates to an aqueous-based solution, wherein the aqueous-based solution includes trace amounts of a chelating agent.

In some embodiments, the present disclosure relates to an aqueous-based solution, wherein the trace amounts of a chelating agent range from 1 part per trillion to 100 parts per million.

### BRIEF DESCRIPTION OF THE DRA WINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

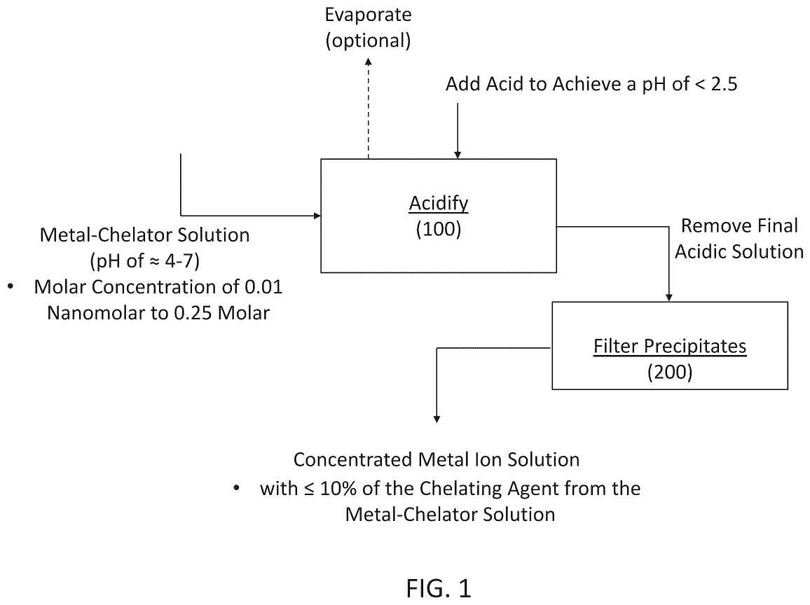

FIG. 1 is a flow diagram of a method for recovering metal ions, in accordance with some embodiments.

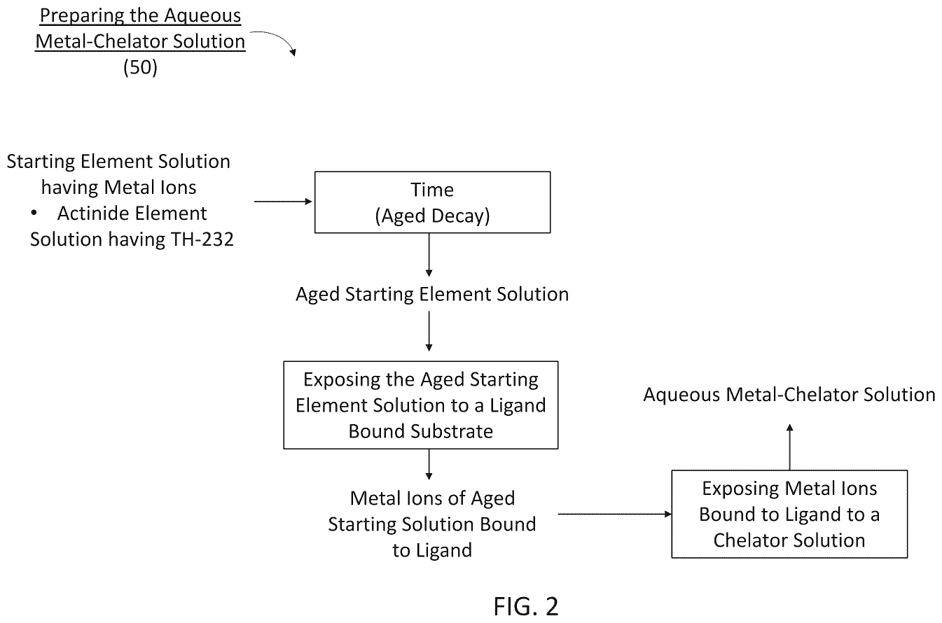

FIG. 2 is a flow diagram of a method for preparing the aqueous metal-chelator solution, in accordance with some embodiments.

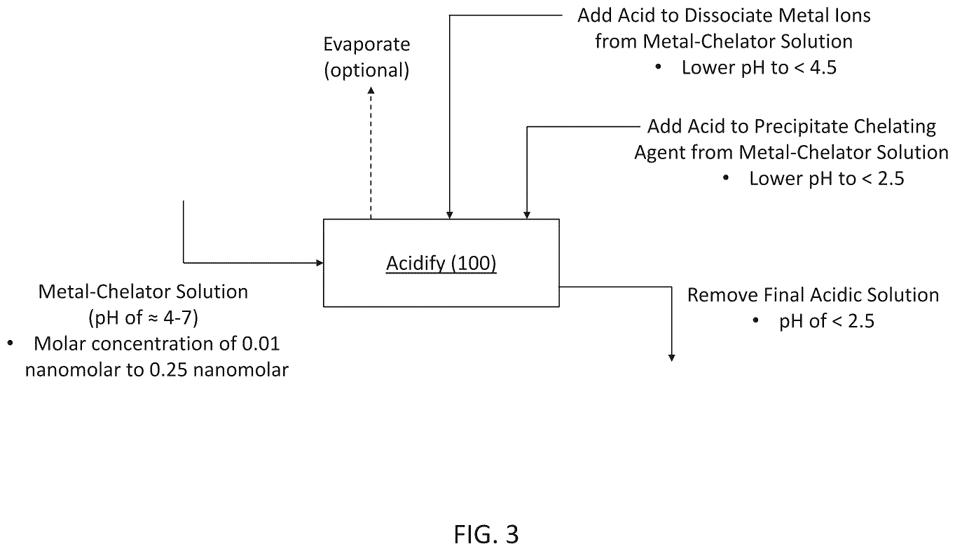

FIG. 3 is a flow diagram of a method for acidifying the aqueous metal-chelator solution, in accordance with some embodiments.

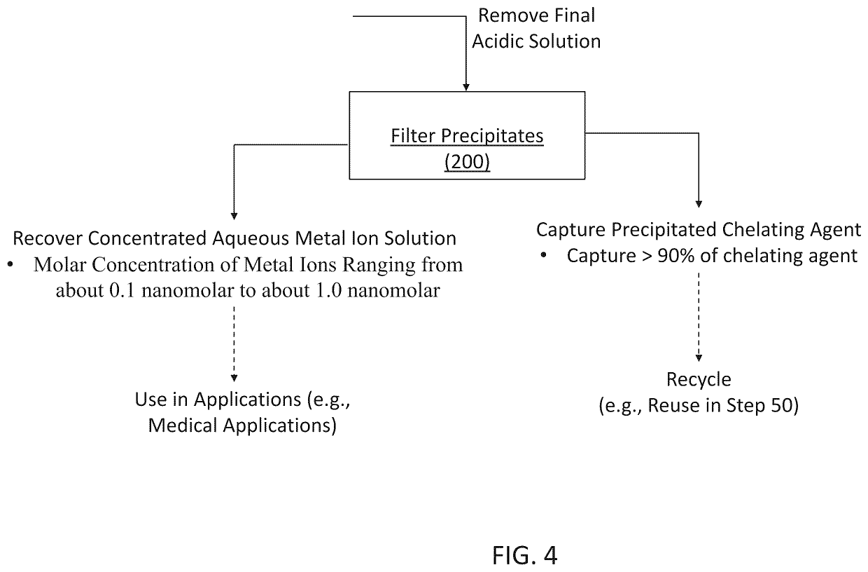

FIG. 4 is a flow diagram of a method for filtering precipitates from the acidic solution, in accordance with some embodiments.

### DETAILED DESCRIPTION

The present disclosure relates to a method for recovering metal ions from chelating agents (e.g., organic chelates in solution). In some instances, the metal ions can be a desired product, instead of (or in addition to) the stripped sequestering agent, the chelating agent.

In some embodiments, solutions with chelating agents, such as ethylenediaminetetraacetic acid (EDTA), can be used to bind metal ions to reduce their free concentration in a broad range of chemical processes. In the present disclosure, metal ions can be captured by an organic ligand bound to a solid substrate from an acidic solution with multiple different elemental components. In high concentration relative to the metal ions, the chelating agent (e.g., an aqueous organic chelate) is capable of extracting metal ions from the solid bound ligand, thus transferring the metal back into solution. One benefit of this technique is that the metal ion has increased in purity with respect to other undesirable ions present in the original liquid solution. The increased purity can be, at least in part, a result of the selectivity of the solid bound ligand. However, the metal ion will sometimes need to be recovered from the solution containing a substantially larger concentration of the chelating agent.

The present disclosure describes a method where the recovery of the metal ions can include various processes to obtain the desired metal ion product. In some embodiments, the method of the present disclosure includes three processes where the metal ion is first dissociated from the chelating agent to form a free chelating agent, the free chelating agent can then be precipitated from the solution or destroyed, and the metal ion can then remain in the acid solution for further processing. The processes of the present disclosure can be accomplished through a variety of procedures, which vary in terms of expense, throughput, and product purity. In some embodiments, the present disclosure includes a preparative process that emphasizes purity and fractional yield from a low-concentration solution, relative to the emphasis on throughput and expense, which is less of a concern for high-value material.

FIG. 1 is a flow diagram of a method for recovering metal ions, in accordance with some embodiments. FIG. 1 displays a general overview of the present disclosure. The method of the present disclosure includes adding acid to an aqueous metal-chelator solution (adding acid step 100) (forming a final acidic solution) and filtering the precipitates (filtering step 200) (e.g., removing the precipitated chelates), forming a concentrated aqueous metal ion solution. Prior to adding acid, the aqueous metal-chelator solution can include metal ions bound to a chelating agent. Due to the adding acid step 100, the metal ions can dissociate from the chelating agent. In addition, the chelating agent can precipitate due to the adding of acid, thereby forming precipitated chelates in the final acidic solution. Removing the precipitated chelates filters the precepted chelates from the final acidic solution.

FIG. 2 is a flow diagram of a method for preparing the aqueous metal-chelator solution (preparing step 50), in accordance with some embodiments. The aqueous metal-chelator solution can be formed by a variety of methods.

In some embodiments, prior to the adding acid step 100, the aqueous metal-chelator solution is formed by aging a starting element solution having metal ions. For example, the starting element solution can be an actinide element solution having Th-232. Th-232 may be used as a precursor for the production of the radioactive isotopes Ra-228, Th-228, and/or Ra-224. Such product solutions including one or more of Ra-228, Th-228, and/or Ra-224 may be suitable for generating Pb-212.

In some embodiments, the starting element solution is a starting actinide element solution. In some embodiments, the starting actinide element solution can include Th-232. Besides using a starting element solution with Th-232, the starting element solution can contain other isotopes, such as U-233 and/or Th-229. In general, the starting element solution can be an acidic solution with Th-232 cations. The starting element solution may be produced via acidification of a Th-232 material or may be produced by dissolution of a Th-232 salt (e.g., Th-232 nitrate). The starting element solution may be aged. The aging time may vary based on the starting element solution. In some embodiments, the starting element solution may be aged not greater than 24 hours or for approximately 24 hours. For example, some starting element solutions containing Ra-224 can be aged for short periods (˜24 hours). In some embodiments, the starting element solution can be aged for longer periods of time (e.g., greater than 24 hours including for months or years). For example, some starting element solutions containing Th-232 can be aged for months or years. Due to the aging (e.g., radioactive decay of Th-232 and/or progeny elements), an aged starting element solution having progeny divalent cations may be produced. The progeny divalent cations (defined below) produced via the radioactive decay of Th-232 may include one or more of Ra-228, Ra-224, Pb-212, and Pb-208.

The aged starting element solution can then be exposed to a substrate, e.g., a ligand bound substrate. The metal ions of the aged starting solution can then be bound to the ligand. The bound metal ions can then be exposed to a chelator solution. The chelator solution (i.e., a solution with a chelating agent) can extract the metal ions from the ligand, thereby forming the aqueous metal-chelator solution.

In some embodiments, prior to the adding acid step 100, the aqueous metal-chelator solution is formed by exposing a solid substrate to an initial solution with the metal ions, capturing the metal ions with the solid substrate from the initial solution, exposing the solid substrate with the captured metal ions to a chelator solution, and extracting the metal ions from the solid substrate with the chelator solution to form the aqueous metal-chelator solution, thereby transferring the metal ions back into solution.

Forming the aqueous metal-chelator solution can include other steps (e.g., an intervening step after capturing the metal ions and before exposing the solid substrate with the captured metal ions to a chelator solution). For example, in some embodiments, prior to the adding acid step 100, the aqueous metal-chelator solution can be evaporated.

The concentration of the metal ions in the initial solution can vary. In some embodiments, the concentration of the metal ions in the initial solution can range from 1 part per trillion (ppt) to 100 parts per million, or any intervening concentration or concentration range. In some embodiments, the concentration of the metal ions in the initial solution is at least 10 parts per billion (ppb). In some embodiments, the concentration of the metal ions in the initial solution can range from 100 ppt to 100 ppm. In some embodiments, the concentration of the metal ions in the initial solution can range from 200 ppt to 100 ppm. In some embodiments, the concentration of the metal ions in the initial solution can range from 300 ppt to 100 ppm. In some embodiments, the concentration of the metal ions in the initial solution can range from 400 ppt to 100 ppm. In some embodiments, the concentration of the metal ions in the initial solution can range from 500 ppt to 100 ppm. In some embodiments, the concentration of the metal ions in the initial solution can range from 600 ppt to 100 ppm. In some embodiments, the concentration of the metal ions in the initial solution can range from 700 ppt to 100 ppm. In some embodiments, the concentration of the metal ions in the initial solution can range from 800 ppt to 100 ppm. In some embodiments, the concentration of the metal ions in the initial solution can range from 900 ppt to 100 ppm. In some embodiments, the concentration of the metal ions in the initial solution can range from 1 ppb to 100 ppm. In some embodiments, the concentration of the metal ions in the initial solution can range from 100 ppb to 100 ppm. In some embodiments, the concentration of the metal ions in the initial solution can range from 200 ppb to 100 ppm. In some embodiments, the concentration of the metal ions in the initial solution can range from 300 ppb to 100 ppm. In some embodiments, the concentration of the metal ions in the initial solution can range from 400 ppb to 100 ppm. In some embodiments, the concentration of the metal ions in the initial solution can range from 500 ppb to 100 ppm. In some embodiments, the concentration of the metal ions in the initial solution can range from 600 ppb to 100 ppm. In some embodiments, the concentration of the metal ions in the initial solution can range from 700 ppb to 100 ppm. In some embodiments, the concentration of the metal ions in the initial solution can range from 800 ppb to 100 ppm. In some embodiments, the concentration of the metal ions in the initial solution can range from 900 ppb to 100 ppm. In some embodiments, the concentration of the metal ions in the initial solution can range from 1 ppm to 100 ppm.

In some embodiments, the concentration of the metal ions in the initial solution can range from 1 ppt to 1 ppm. In some embodiments, the concentration of the metal ions in the initial solution can range from 1 ppt to 900 ppb. In some embodiments, the concentration of the metal ions in the initial solution can range from 1 ppt to 800 ppb. In some embodiments, the concentration of the metal ions in the initial solution can range from 1 ppt to 700 ppb. In some embodiments, the concentration of the metal ions in the initial solution can range from 1 ppt to 600 ppb. In some embodiments, the concentration of the metal ions in the initial solution can range from 1 ppt to 500 ppb. In some embodiments, the concentration of the metal ions in the initial solution can range from 1 ppt to 400 ppb. In some embodiments, the concentration of the metal ions in the initial solution can range from 1 ppt to 300 ppb. In some embodiments, the concentration of the metal ions in the initial solution can range from 1 ppt to 200 ppb. In some embodiments, the concentration of the metal ions in the initial solution can range from 1 ppt to 100 ppb. In some embodiments, the concentration of the metal ions in the initial solution can range from 1 ppt to 1 ppb. In some embodiments, the concentration of the metal ions in the initial solution can range from 1 ppt to 900 ppt. In some embodiments, the concentration of the metal ions in the initial solution can range from 1 ppt to 800 ppt. In some embodiments, the concentration of the metal ions in the initial solution can range from 1 ppt to 700 ppt. In some embodiments, the concentration of the metal ions in the initial solution can range from 1 ppt to 600 ppt. In some embodiments, the concentration of the metal ions in the initial solution can range from 1 ppt to 500 ppt. In some embodiments, the concentration of the metal ions in the initial solution can range from 1 ppt to 400 ppt. In some embodiments, the concentration of the metal ions in the initial solution can range from 1 ppt to 300 ppt. In some embodiments, the concentration of the metal ions in the initial solution can range from 1 ppt to 200 ppt. In some embodiments, the concentration of the metal ions in the initial solution can range from 1 ppt to 100 ppt.

The metal-chelator molar concentration of the aqueous metal-chelator solution can vary. In some embodiments, prior to the adding acid step 100, the aqueous metal-chelator solution can have a metal-chelator molar concentration ranging from 0.01 nanomolar to 0.25 molar, or any intervening concentration or concentration range. In some embodiments, the aqueous metal-chelator solution has a metal-chelator molar concentration of 0.1 nanomolar. In some embodiments, the aqueous metal-chelator solution can have a metal-chelator molar concentration ranging from 0.1 nanomolar to 0.25 molar. In some embodiments, the aqueous metal-chelator solution can have a metal-chelator molar concentration ranging from 1 nanomolar to 0.25 molar. In some embodiments, the aqueous metal-chelator solution can have a metal-chelator molar concentration ranging from 10 nanomolar to 0.25 molar. In some embodiments, the aqueous metal-chelator solution can have a metal-chelator molar concentration ranging from 100 nanomolar to 0.25 molar. In some embodiments, the aqueous metal-chelator solution can have a metal-chelator molar concentration ranging from 1 micromolar to 0.25 molar. In some embodiments, the aqueous metal-chelator solution can have a metal-chelator molar concentration ranging from 10 micromolar to 0.25 molar. In some embodiments, the aqueous metal-chelator solution can have a metal-chelator molar concentration ranging from 100 micromolar to 0.25 molar. In some embodiments, the aqueous metal-chelator solution can have a metal-chelator molar concentration ranging from 1 millimolar to 0.25 molar. In some embodiments, the aqueous metal-chelator solution can have a metal-chelator molar concentration ranging from 10 millimolar to 0.25 molar. In some embodiments, the aqueous metal-chelator solution can have a metal-chelator molar concentration ranging from 0.1 molar to 0.25 molar.

In some embodiments, the aqueous metal-chelator solution can have a metal-chelator molar concentration ranging from 0.01 nanomolar to 0.1 molar. In some embodiments, the aqueous metal-chelator solution can have a metal-chelator molar concentration ranging from 0.01 nanomolar to 10 millimolar. In some embodiments, the aqueous metal-chelator solution can have a metal-chelator molar concentration ranging from 0.01 nanomolar to 1 millimolar. In some embodiments, the aqueous metal-chelator solution can have a metal-chelator molar concentration ranging from 0.01 nanomolar to 100 micromolar. In some embodiments, the aqueous metal-chelator solution can have a metal-chelator molar concentration ranging from 0.01 nanomolar to 10 micromolar. In some embodiments, the aqueous metal-chelator solution can have a metal-chelator molar concentration ranging from 0.01 nanomolar to 1 micromolar. In some embodiments, the aqueous metal-chelator solution can have a metal-chelator molar concentration ranging from 0.01 nanomolar to 100 nanomolar. In some embodiments, the aqueous metal-chelator solution can have a metal-chelator molar concentration ranging from 0.01 nanomolar to 10 nanomolar. In some embodiments, the aqueous metal-chelator solution can have a metal-chelator molar concentration ranging from 0.01 nanomolar to 1 nanomolar. In some embodiments, the aqueous metal-chelator solution can have a metal-chelator molar concentration ranging from 0.01 nanomolar to 0.1 nanomolar.

The aqueous metal-chelator solution can include various metal ions. In some embodiments, the aqueous metal-chelator solution includes radium isotopes. The radium isotopes can include Ra-223, Ra-224, Ra-225, Ra-226, or Ra-228.

The chelating agent can include various acids. In some embodiments, the acids can be ethylenediaminetetraacetic acid, nitrilotriacetic acid, and/or citric acid.

FIG. 3 is a flow diagram of a method for acidifying the aqueous metal-chelator solution (adding acid step 100), in accordance with some embodiments. The adding acid step 100 of FIG. 1 and FIG. 3 can be the same or substantially similar. In some embodiments, the adding acid step 100 of FIG. 3 is a detailed description of the adding acid step 100 of FIG. 1. Prior to the adding acid step 100, the aqueous metal-chelator solution can be acidic. For example, prior to the adding acid step 100, the aqueous metal-chelator solution can have a pH ranging from 4 to 7. In some embodiments, the aqueous metal-chelator solution can have a pH ranging from 4.5 to 7. In some embodiments, the aqueous metal-chelator solution can have a pH ranging from 5 to 7. In some embodiments, the aqueous metal-chelator solution can have a pH ranging from 5.5 to 7. In some embodiments, the aqueous metal-chelator solution can have a pH ranging from 6 to 7. In some embodiments, the aqueous metal-chelator solution can have a pH ranging from 6.5 to 7. In some embodiments, the aqueous metal-chelator solution can have a pH ranging from 4 to 6.5. In some embodiments, the aqueous metal-chelator solution can have a pH ranging from 4 to 5.5. In some embodiments, the aqueous metal-chelator solution can have a pH ranging from 4 to 5. In some embodiments, the aqueous metal-chelator solution can have a pH ranging from 4 to 4.5.

In some embodiments, prior to the adding acid step 100, the aqueous metal-chelator solution can be evaporated. The aqueous metal-chelator solution can be evaporated to reduce the working volume and/or increase ionic strength to favor pH manipulation of chelator-metal dissociation and chelator solubility.

The method of the present disclosure includes stepwise dissociation and precipitation of the chelator from the aqueous metal-chelator solution by increasing acidity (reducing the pH) of the aqueous metal-chelator solution. Reducing the pH of the aqueous metal-chelator solution can include adding an acid. In some embodiments, adding an acid includes adding a concentrated acid (e.g., a concentrated acid of hydrochloric acid or nitric acid). Due to the adding acid step 100, the metal ions disassociate from the chelating agent. In some embodiments, the metal ions dissociate from the chelating agent at a pH of 4.5 or less. In some embodiments, the metal ions dissociate from the chelating agent at a pH of 5 or less. In some embodiments, the metal ions dissociate from the chelating agent at a pH of 4 or less. In some embodiments, the metal ions dissociate from the chelating agent at a pH of 3.5 or less.

The present disclosure includes continuing to add acid to the aqueous metal-chelator solution until the pH has reached a predetermined level of acidity and/or the chelating agent precipitates from the aqueous metal-chelator solution. For example, the present disclosure includes continuing to titrate the acid until the pH is reduced below ˜2.5 (lower in some embodiments). In one example, protonation of the coordinating carboxyl groups of the organic chelate of the aqueous metal-chelator solution yield the organic chelate insoluble, and the organic chelate will precipitate, leaving in solution the free metal ion of the aqueous metal-chelator solution.

In some embodiments, due to the adding acid step 100, the chelating agent precipitates from the aqueous metal-chelator solution at a pH of 2.5 or less. In some embodiments, due to the adding acid step 100, the chelating agent precipitates from the aqueous metal-chelator solution at a pH of 3.5 or less. In some embodiments, due to the adding acid step 100, the chelating agent precipitates from the aqueous metal-chelator solution at a pH of 3 or less. In some embodiments, due to the adding acid step 100, the chelating agent precipitates from the aqueous metal-chelator solution at a pH of 2 or less.

In some embodiments, due to the adding acid step 100, the aqueous metal-chelator solution realizes a pH of not greater than 2.5. In some embodiments, due to the adding acid step 100, the aqueous metal-chelator solution realizes a pH of not greater than 3.5. In some embodiments, due to the adding acid step 100, the aqueous metal-chelator solution realizes a pH of not greater than 3. In some embodiments, due to the adding acid step 100, the aqueous metal-chelator solution realizes a pH of not greater than 2. After the adding acid step 100, the final acidic solution is formed. The final acidic solution can be removed, e.g., for filtering out the precipitated chelating agent from the aqueous metal-chelator solution.

In some embodiments, the aqueous metal-chelator solution can be a metal-EDTA complex. Without wishing to be bound to theory, below a pH of approximately 4, the metal-EDTA complex dissociates, and below a pH of approximately 2.5 (a pH of approximately 1.7 for complete dissociation), the solubility of EDTA is dramatically reduced, resulting in EDTA precipitation. The metal ions remain in solution and the EDTA is a precipitated chelate.

FIG. 4 is a flow diagram of a method for filtering precipitates from the acidic solution (filtering step 200), in accordance with some embodiments. The filtering step 200 of FIG. 1 and FIG. 4 can be the same or substantially similar. In some embodiments, the filtering step 200 of FIG. 4 is a detailed description of the filtering step 200 of FIG. 1. Through filtration of precipitated chelate salts from the final acidic solution, metal ions can be recovered. Furthermore, the metal ions can remain in the aqueous metal-chelator solution. In some embodiments, the final acidic solution has the precipitated chelator of the aqueous metal-chelator solution, and the metal ions in solution. The final acidic solution can be passed through a filter to remove the precipitated chelate (e.g., the chelating agent such as an organic chelate). After filtering out the precipitated chelate, what remains is acidic solution with the metal ion in solution, a concentrated aqueous metal ion solution.

In some embodiments, filtering out the precipitated chelate removes upward of 90% of the chelate (e.g., EDTA) from the aqueous metal-chelator solution. In some embodiments, filtering out the precipitated chelate removes upward of 91% of the chelate (e.g., EDTA) from the aqueous metal-chelator solution. In some embodiments, filtering out the precipitated chelate removes upward of 92% of the chelate (e.g., EDTA) from the aqueous metal-chelator solution. In some embodiments, filtering out the precipitated chelate removes upward of 93% of the chelate (e.g., EDTA) from the aqueous metal-chelator solution. In some embodiments, filtering out the precipitated chelate removes upward of 94% of the chelate (e.g., EDTA) from the aqueous metal-chelator solution. In some embodiments, filtering out the precipitated chelate removes upward of 95% of the chelate (e.g., EDTA) from the aqueous metal-chelator solution. In some embodiments, filtering out the precipitated chelate removes upward of 96% of the chelate (e.g., EDTA) from the aqueous metal-chelator solution. In some embodiments, filtering out the precipitated chelate removes upward of 97% of the chelate (e.g., EDTA) from the aqueous metal-chelator solution. In some embodiments, filtering out the precipitated chelate removes upward of 98% of the chelate (e.g., EDTA) from the aqueous metal-chelator solution. In some embodiments, filtering out the precipitated chelate removes upward of 99% of the chelate (e.g., EDTA) from the aqueous metal-chelator solution. In some embodiments, filtering out the precipitated chelate removes upward of 99.5% of the chelate (e.g., EDTA) from the aqueous metal-chelator solution. In some embodiments, filtering out the precipitated chelate removes upward of 99.9% of the chelate (e.g., EDTA) from the aqueous metal-chelator solution.

Stated another way, in some embodiments, the concentrated aqueous metal ion solution can be less than 10% of the chelating agent from the aqueous metal-chelator solution. In some embodiments, the concentrated aqueous metal ion solution can be less than 9% of the chelating agent from the aqueous metal-chelator solution. In some embodiments, the concentrated aqueous metal ion solution can be less than 8% of the chelating agent from the aqueous metal-chelator solution. In some embodiments, the concentrated aqueous metal ion solution can be less than 7% of the chelating agent from the aqueous metal-chelator solution. In some embodiments, the concentrated aqueous metal ion solution can be less than 6% of the chelating agent from the aqueous metal-chelator solution. In some embodiments, the concentrated aqueous metal ion solution can be less than 5% of the chelating agent from the aqueous metal-chelator solution. In some embodiments, the concentrated aqueous metal ion solution can be less than 4% of the chelating agent from the aqueous metal-chelator solution. In some embodiments, the concentrated aqueous metal ion solution can be less than 3% of the chelating agent from the aqueous metal-chelator solution. In some embodiments, the concentrated aqueous metal ion solution can be less than 2% of the chelating agent from the aqueous metal-chelator solution. In some embodiments, the concentrated aqueous metal ion solution can be less than 1% of the chelating agent from the aqueous metal-chelator solution. In some embodiments, the concentrated aqueous metal ion solution can be less than 0.5% of the chelating agent from the aqueous metal-chelator solution. In some embodiments, the concentrated aqueous metal ion solution can be less than 0.1% of the chelating agent from the aqueous metal-chelator solution.

After filtering out the precipitated chelating agent from the final acidic solution, the chelating agent can be recycled. For example, the precipitated chelating agent can be reused in the preparing step 50 of FIG. 2.

The molar concentration of metal ions in the concentrated aqueous metal ion solution can vary. In some embodiments, the molar concentration of metal ions in the concentrated aqueous metal ion solution ranges from 0.1 nanomolar to 1.0 nanomolar, or any intervening number or range. For example, the molar concentration of metal ions in the concentrated aqueous metal ion solution can be 0.2 nanomolar.

In some embodiments, the molar concentration of metal ions in the concentrated aqueous metal ion solution can range from 0.1 nanomolar to 0.9 nanomolar. In some embodiments, the molar concentration of metal ions in the concentrated aqueous metal ion solution can range from 0.1 nanomolar to 0.8 nanomolar. In some embodiments, the molar concentration of metal ions in the concentrated aqueous metal ion solution can range from 0.1 nanomolar to 0.7 nanomolar. In some embodiments, the molar concentration of metal ions in the concentrated aqueous metal ion solution can range from 0.1 nanomolar to 0.6 nanomolar. In some embodiments, the molar concentration of metal ions in the concentrated aqueous metal ion solution can range from 0.1 nanomolar to 0.5 nanomolar. In some embodiments, the molar concentration of metal ions in the concentrated aqueous metal ion solution can range from 0.1 nanomolar to 0.4 nanomolar. In some embodiments, the molar concentration of metal ions in the concentrated aqueous metal ion solution can range from 0.1 nanomolar to 0.3 nanomolar. In some embodiments, the molar concentration of metal ions in the concentrated aqueous metal ion solution can range from 0.1 nanomolar to 0.2 nanomolar. In some embodiments, the molar concentration of metal ions in the concentrated aqueous metal ion solution can range from 0.2 nanomolar to 1.0 nanomolar. In some embodiments, the molar concentration of metal ions in the concentrated aqueous metal ion solution can range from 0.3 nanomolar to 1.0 nanomolar. In some embodiments, the molar concentration of metal ions in the concentrated aqueous metal ion solution can range from 0.4 nanomolar to 1.0 nanomolar. In some embodiments, the molar concentration of metal ions in the concentrated aqueous metal ion solution can range from 0.5 nanomolar to 1.0 nanomolar. In some embodiments, the molar concentration of metal ions in the concentrated aqueous metal ion solution can range from 0.6 nanomolar to 1.0 nanomolar. In some embodiments, the molar concentration of metal ions in the concentrated aqueous metal ion solution can range from 0.7 nanomolar to 1.0 nanomolar. In some embodiments, the molar concentration of metal ions in the concentrated aqueous metal ion solution can range from 0.8 nanomolar to 1.0 nanomolar. In some embodiments, the molar concentration of metal ions in the concentrated aqueous metal ion solution can range from 0.9 nanomolar to 1.0 nanomolar.

In some embodiments, the method of the present disclosure includes recovering the metal ions from the concentrated aqueous metal ion solution. In some embodiments, the method of the present disclosure includes using the concentrated aqueous metal ion solution. Using the concentrated aqueous metal ion solution can include using the metal ions of the concentrated aqueous metal ion solution in a medical application or an industrial application. In some embodiments, medical applications include medical therapies such as cancer therapies and targeted alpha therapies. Using the concentrated aqueous metal ion solution can include using the metal ions of the concentrated aqueous metal ion solution as a source material to produce Pb-212, Bi-212, Ac-225, Th-227, Th-228, Ra-223, or Ra-224.

The present disclosure includes an aqueous-based solution with a molar concentration of metal ions ranging from 0.1 nanomolar to 10 micromolar. In some embodiments, the metal ions can include Ra-223, Ra-224, Ra-225, Ra-226, Ra-228, Ac-228, Th-228, Rn-220, Po-216, Pb-212, Bi-212, Po-212, Tl-208, and Pb-208. In some embodiments, the present disclosure includes an aqueous-based solution with a molar concentration of Ra-226 ions ranging from 0.1 nanomolar to 10 micromolar, or any intervening molar concentration or concentration range. In some embodiments, the molar concentration of the ions is 5 nanomolar. In some embodiments, the molar concentration of the ions ranges from 10 nanomolar to 10 micromolar. In some embodiments, the molar concentration of the ions ranges from 100 nanomolar to 10 micromolar. In some embodiments, the molar concentration of the ions ranges from 1 micromolar to 10 micromolar. In some embodiments, the molar concentration of the ions ranges from 0.1 nanomolar to 1 micromolar. In some embodiments, the molar concentration of the ions ranges from 0.1 nanomolar to 1 micromolar. In some embodiments, the molar concentration of the ions ranges from 0.1 nanomolar to 100 nanomolar. In some embodiments, the molar concentration of the ions ranges from 0.1 nanomolar to 10 nanomolar. In some embodiments, the molar concentration of the ions ranges from 0.1 nanomolar to 1 nanomolar.

In some embodiments, the aqueous-based solution includes trace amounts of a chelating agent. In some embodiments, a chelating agent has been completely removed from the aqueous-based solution, leaving no trace amounts of a chelating agent. In some embodiments, the trace amounts of a chelating agent range from 1 part per trillion (ppt) to 100 parts per million (ppm), or intervening amount or range. For example, in some embodiments, the trace amounts of a chelating agent are 20 ppt. In some embodiments, the trace amounts of a chelating agent range from 1 ppt to 10 ppm. In some embodiments, the trace amounts of a chelating agent range from 1 ppt to 1 ppm. In some embodiments, the trace amounts of a chelating agent range from 1 ppt to 100 parts per billion (ppb). In some embodiments, the trace amounts of a chelating agent range from 1 ppt to 10 ppb. In some embodiments, the trace amounts of a chelating agent range from 1 ppt to 1 ppb. In some embodiments, the trace amounts of a chelating agent range from 1 ppt to 100 ppt. In some embodiments, the trace amounts of a chelating agent range from 1 ppt to 10 ppt. In some embodiments, the trace amounts of a chelating agent range from 10 ppt to 100 ppm. In some embodiments, the trace amounts of a chelating agent range from 100 ppt to 100 ppm. In some embodiments, the trace amounts of a chelating agent range from 1 ppb to 100 ppm. In some embodiments, the trace amounts of a chelating agent range from 10 ppb to 100 ppm. In some embodiments, the trace amounts of a chelating agent range from 100 ppb to 100 ppm. In some embodiments, the trace amounts of a chelating agent range from 1 ppm to 100 ppm. In some embodiments, the trace amounts of a chelating agent range from 10 ppm to 100 ppm.

In some embodiments, the method of the present disclosure may need multiple cycles of the method steps outlined herein to achieve sufficient removal of the chelating agent. For example, when the aqueous metal-chelator solution has a molar ratio (chelating agent/metal) of 2-3 orders of magnitude or greater, the method of the present disclosure may need more than one cycle of the method of the present disclosure. Additional procedures may also be required to reduce the concentration of the chelating agent via degradation or other means of chelator separation. Upon alkalization, this will permit efficient precipitation of the free metal ions rather than re-sequestration by any remaining (if any) soluble chelating agent. Such additional procedures may include UV photolysis, H2O2 oxidation, and alumina adsorption.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, “divalent cations” means an element having a charge of +2. Non-limiting examples of divalent cations include radium isotopes and lead isotopes, among others.

As used herein, “progeny” means one or more elements produced as a result of radioactive decay of a prior element. For example, the progeny of element Th-232 include Ra-224, Ra-226, Ra-228, Ac-228, Th-228, Rn-220, Po-216, Pb-212, Bi-212, Po-212, TI-208, and Pb-208.

As used herein, a “progeny cation” is a cation produced as a result of radioactive decay of a prior cation. For example, a Th-232 tetravalent (+4) cation may decay into a Ra-228 divalent (+2) cation via emission of an alpha particle. The progeny cation can be the Ra-228 divalent cation.

As used herein, “a progeny divalent cation” is a divalent cation produced as a result of radioactive decay of a prior cation.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

What is claimed is:

1. A method comprising:
(a) adding acid to an aqueous metal-chelator solution,
wherein, prior to the adding acid step, the aqueous metal-chelator solution comprises metal ions bound to a chelating agent,
wherein, due to the adding acid step, the metal ions disassociate from the chelating agent, and
wherein, due to the adding acid step, the chelating agent precipitates thereby forming precipitated chelates, and
(b) removing the precipitated chelates, thereby forming a concentrated aqueous metal ion solution.

2. The method of claim 1, further comprising, prior to the adding acid step:
exposing a solid substrate to an initial solution comprising the metal ions;
capturing the metal ions with the solid substrate from the initial solution;
exposing the solid substrate with the captured metal ions to a chelator solution; and
extracting the metal ions from the solid substrate with the chelator solution to form the aqueous metal-chelator solution, thereby transferring the metal ions back into solution.

3. The method of claim 1, wherein the metal ions in the initial solution have a concentration ranging from 1 part per trillion to 100 parts per million.

4. The method of claim 1, further comprising, prior to the adding acid step, evaporating the aqueous metal-chelator solution.

5. The method of claim 1, wherein, prior to the adding acid step, the aqueous metal-chelator solution comprises a metal-chelator molar concentration ranging from 0.01 nanomolar to 0.25 molar.

6. The method of claim 1, wherein the aqueous metal-chelator solution comprises radium isotopes.

7. The method of claim 1, wherein the radium isotopes comprise at least one of Ra-223, Ra-224, Ra-225, Ra-226, and Ra-228.

8. The method of claim 1, wherein the chelating agent comprises at least one of ethylenediaminetetraacetic acid, nitrilotriacetic acid, and citric acid.

9. The method of claim 1, wherein, prior to the adding acid step, the aqueous metal-chelator solution comprises a pH of from 4 to 7.

10. The method of claim 1, wherein, due to the adding acid step, the metal ions disassociate from the chelating agent at a pH of 4.5 or less.

11. The method of claim 1, wherein, due to the adding acid step, the chelating agent precipitates at a pH of 2.5 or less.

12. The method of claim 1, wherein, due to the adding acid step, the aqueous metal-chelator solution realizes a pH of not greater than 2.5.

13. The method of claim 1, wherein the acid comprises hydrochloric acid or nitric acid.

14. The method of claim 1, further comprising recovering the metal ions from the concentrated aqueous metal ion solution.

15. The method of claim 1, further comprising using the concentrated aqueous metal ion solution in a medical application.

16. The method of claim 1, further comprising using the concentrated aqueous metal ion solution as a source material to produce Pb-212, Bi-212, Ac-225, Th-227, Th-228, Ra-223, or Ra-224.

17. The method of claim 1, wherein the concentrated aqueous metal ion solution comprises not greater than 10% of the chelating agent from the aqueous metal-chelator solution.

18. An aqueous-based solution, comprising:
a molar concentration of Ra-226 ions ranging from 0.1 nanomolar to 10 micromolar, wherein the aqueous-based solution comprises trace amounts of a chelating agent.

19. The aqueous-based solution of claim 18, wherein the trace amounts of a chelating agent range from 1 part per trillion to 100 parts per million.
